(19) United States
(12) Patent Application Publication
(10) Pub. No.: US 2007/0289456 A1
(43) Pub. Date: Dec. 20, 2007

(54) PNEUMATIC PRESS WITH HOSE ACTUATOR

(76) Inventor: Daniel Kowalski, Legal (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/764,753

(22) Filed: Jun. 18, 2007

(30) Foreign Application Priority Data
Jun. 20, 2006 (CA) 2550778

(51) Int. Cl. B30B 1/32

(52) U.S. Cl. 100/269.01

(57) ABSTRACT

A pneumatic press includes a hose actuator, a backing support for the hose actuator, and a material support. The backing support is adapted to be secured to a rigid work surface. The material support is positioned in spaced relation to the backing support. When the hose actuator is inflated it expands outwardly to press material against the material support. The hose actuator is placed under vacuum in order to facilitate insertion and removal of material.

### FIELD OF THE INVENTION

The present invention relates to a pneumatic press in which a hose is inflated to exert pressure upon a work piece.

### BACKGROUND OF THE INVENTION

In wood working, it is often necessary to glue pieces of wood together to form laminated structures or frames. During gluing operations it is difficult to get even clamping pressure along the work piece.

### SUMMARY OF THE INVENTION

There is provided a pneumatic press, comprising a hose actuator and a backing support for the hose actuator adapted to be secured to a rigid work surface. A material support is positioned in spaced relation to the backing support. Means are provided for inflating the hose actuator, thereby causing the hose actuator to expand outwardly to press material against the material support. Means are provided for creating a vacuum in the hose actuator to facilitate insertion and removal of material. As will hereinafter be further described, the backing support and the material support may be in various configurations.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a first embodiment of pneumatic press with a linear configuration of backing support and material support.

FIG. 2 is a top plan view of a second embodiment of pneumatic press with an arcuate configuration of backing support and material support.

FIG. 3 is a top plan view of a third embodiment of pneumatic press with a rectangular configuration of backing support and material support.

FIG. 4 is a detailed top plan view of a corner from the pneumatic press illustrated in FIG. 3.

FIG. 5 is a detailed perspective view of a corner from the pneumatic press illustrated in FIG. 3.

### DETAILED DESCRIPTION OF A PNEUMATIC PRESS

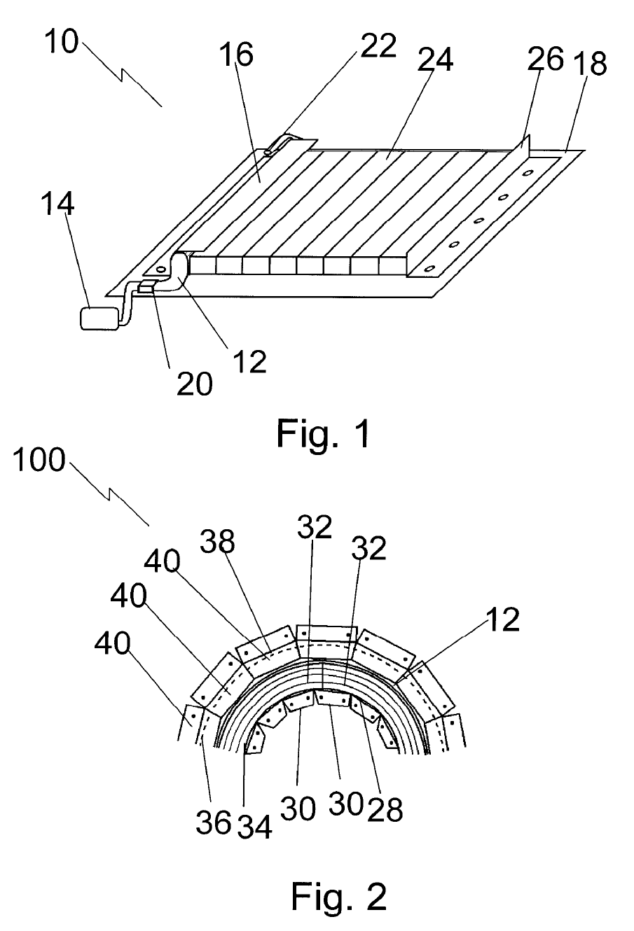

FIG. 1 describes a first embodiment of pneumatic press, generally indicated by reference numeral 10. Press 10 includes a pump assembly 14, and a hose actuator 12. Hose actuator 12 is held under tension against a linear backing support 16, which is secured to a rigid underlying work surface 18. Linear backing support 16 has an overhanging structure 19. Overhanging structure 19 enables linear backing support 16 to encompass hose actuator 12 and prevent it from lifting off work surface 18 upon inflation. A first end 20 and second end 22 of hose actuator 12 may be secured to work surface 18 in order to place hose actuator 12 in tension.

Alternatively, first end 20 or second end 22, may be secured to backing support 16 in order to place hose actuator 12 in tension. A linear material support 26 is secured to working surface 18 in spaced relation to backing support 16. Material 24, in this application consisting of several boards to be glued together, is placed between material support 26 and hose actuator 12 which rests tightly against backing support 16.

In order to facilitate inflation, a remote end of hose actuator is plugged. Upon inflation, the hose actuator 12 expands outward from linear backing support 16 and applies pressure to press material 24 being glued together against material support 26. Hose actuator is kept inflated until the glue has set. In this application for gluing materials 24, pump assembly 14 is preferably capable of providing pressures above atmospheric pressure necessary for operation, in the order of 50 psi-150 psi when run in inflation mode. When the glue has set, pump assembly 14 is switched to deflation mode. This results in pump assembly 14 applying a vacuum to hose actuator 12. When under vacuum, hose actuator 12 is drawn substantially flat. With hose actuator 12 substantially flat, material 24 is easily removed from the press 10. Hose actuator 12 is made from hose that can contain pressures within the desired pressure range without deforming and expanding like a balloon. It must be appreciated that there is normally negligible difference between hose actuator 12 inflated and hose actuator at atmospheric pressure. For this reason, it is preferred to place hose actuator under vacuum to collapse hose actuator 12 and increased the difference. It has been found that maintaining the hose actuator 12 in tension against backing support 16 provides more room for insertion and removal of material 24, when vacuum is applied. When hose actuator 12 is not in tension, problems may arise of the hose actuator twisting and not lying flat. Twisting seemed more prevalent with some brands of hose, as compared to other brands of hose. It is believed that this is due to differences in manufacturing processes. An alternative to securing linear material support 26 to rigid work surface 18 would be to have a rigid linkage to linear backing support 16 which will maintain the relative spacing as pressure is applied by hose actuator 12. It is preferred that rigid work surface 18 be a non-stick surface in order to avoid material 24 becoming glued to rigid work surface 18. An alternative would be to place wax paper or another buffer substrate between material 24 and rigid work surface 18.

Referring to FIG. 2, there is illustrated a second embodiment of pneumatic press, generally identified by reference numeral 100, which is curved. In the example provided pneumatic press 100 is curved into an arcuate configuration. It will be appreciated that a more complex curved structure is possible. A curved material support 28 is provided. In the example given a linear support has had triangular pieces removed to allow it to bend in the desired curvature. The removal of the triangular pieces creates a chain of attached and relatively smaller linear material supports 30, which can be manipulated to the desired curvature. A curved backing support 38 is provided which includes a chain of attached and relatively smaller linear backing supports 40. As with curved material support 28, a linear backing support has had triangular pieces removed to allow it to bend in the desired curvature. The removal of the triangular pieces creates a chain of attached and relatively smaller linear backing supports 40, which can be manipulated to the desired curvature. In preparation for use curved backing support 38 is secured to the rigid work surface 18. As described above each of linear backing supports 40 has a confining overhanging portion. Hose actuator 12 is then fitted in place against curved backing support 38. As described above, it is preferred that hose actuator 12 be maintained in tension, although this is not possible with all curvatures. Pliable material 32 to be glued together is then laid in position and curved material support 28 is secured in position to rigid work surface 18 in spaced relation to curved backing support 38. Material 32 is confined between curved profile 34 of the curved material support 28 and curved profile 36 of curved backing support 38. As described above, hose actuator 12 is hooked up to a pump assembly (not shown in this figure). Upon inflation of hose actuator 12, material 32 to be glued together is pressed up against curved material support 28 and left so that the glue may dry. After the drying period, the hose actuator 12 is placed under vacuum and material 32 removed. It will be appreciated that, if a different manufacturing process was used, curved material support 28 and curved backing support 38 need not be formed in segments. The use of segments has been selected to show how a linear support can readily be converted into a curved support.

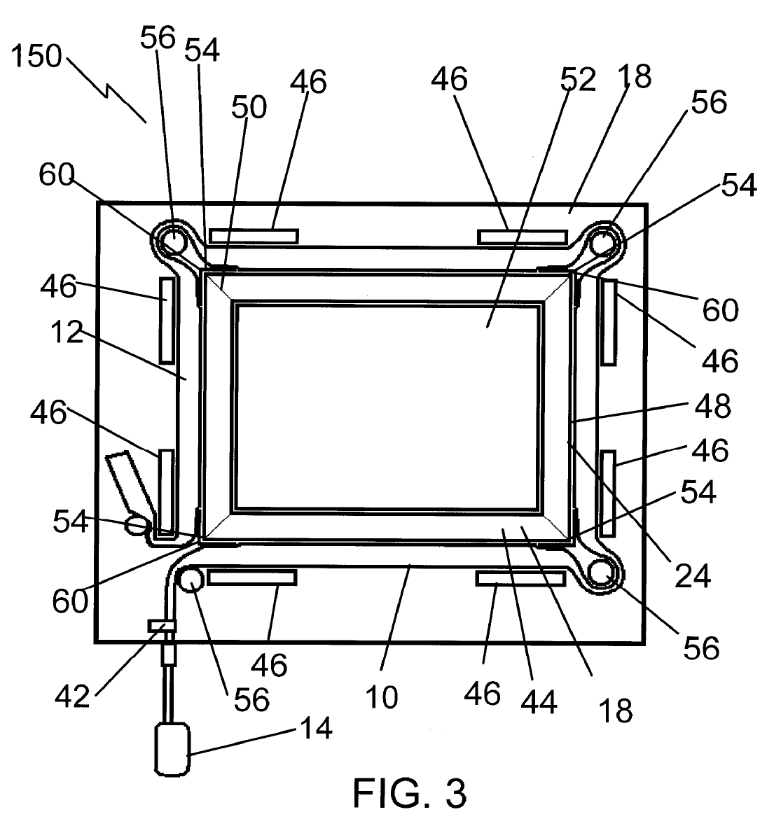

FIG. 3 illustrates a third embodiment of pneumatic press, generally indicated by reference numeral 150. The particular embodiment selected for illustration is in a rectangular configuration. It will be appreciated that other configurations can be used, as will hereinafter be further described. In this embodiment, a peripheral backing support 46 is provided. Peripheral backing support 46 is secured to rigid work surface 18, and surrounds the outer periphery 48 of the material 24 being fitted together. As illustrated, peripheral backing support 46 consists of short linear backing support sections, as it is not essential to have continuous support around outer periphery 48. In the illustrated embodiment, outer periphery 48 is rectangular. It will be appreciated that outer periphery 48 may be any polygon shape.

Glue is applied to mitred joints 50 of the material 24 that contact each other, so that they can be fitted together to form a picture frame 44. As described above, wax paper may be placed underlying material 24, to prevent picture frame 44 from being glued to rigid work surface 18. A central material support 52 provides internal support for picture frame 44. In the illustrated embodiment central material support 52 is a rectangular plug that fits inside the picture frame 44. Central material support 52 need not be secured to rigid work surface 18, as the system will self align when pressure is applied.

As with the other embodiments, peripheral backing support 46 is secured to rigid work surface 18. Hose actuator 12 is then positioned against peripheral backing support 46. Unlike the other embodiments, it is preferred that hose actuator 12 not be placed in tension for reasons that will hereinafter be further explained. Pump assembly 14 is provided to selectively inflate or deflate hose actuator 12. It will be appreciated that as an alternative two pump assemblies may be connected to the hose actuator 12, one serving to inflate hose actuator 12 and the other serving to deflate hose actuator 12. In this embodiment, four pieces which comprise picture frame 44 are glued and then set into position within peripheral backing support 46. Central material support 52 is then placed inside picture frame 44. When the hose actuator 12 is inflated, it expands and applies pressure directly to picture frame 44, pressing it up against central material support 52. As central material support 52 is rectangular, picture frame 44 is pressed into a matching rectangular configuration.

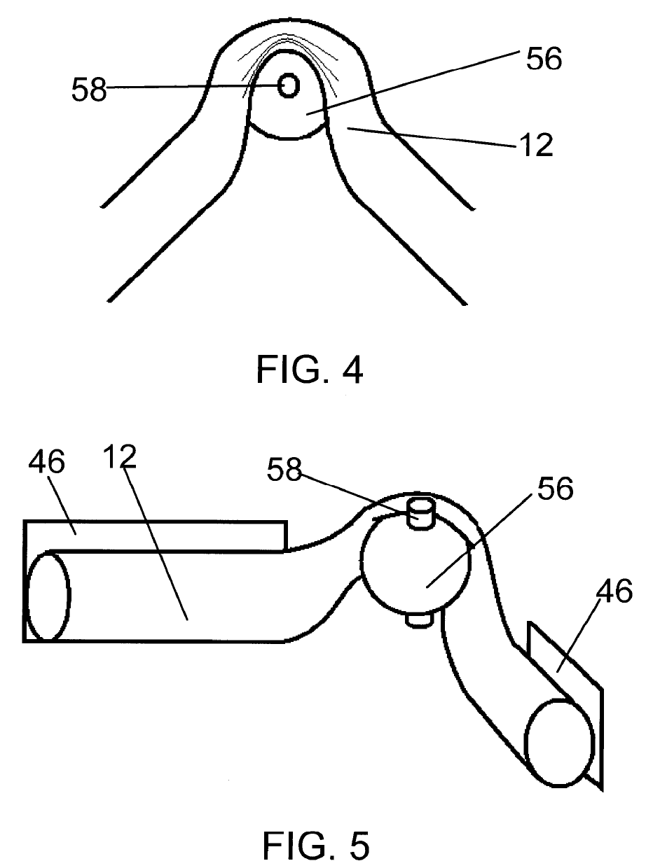

In order for the hose actuator 12 to change directions around the corners 54 of the picture frame 44, spherical corner stops 56 may be used as shown in FIGS. 4 and 5. A typical corner stop 56 comprises a sphere, secured on a small bolt 58 that is attached securely to the rigid work surface 18. By using corner stops 56 with a spherical shape, this prevents the hose actuator 12 from totally collapsing during deflation. The spherical shape exerts pressure in the middle, but leaves unrestricted flow spaces at the outer edges of contact between hose actuator 12 and the sphere. Without spherical corner stops 56, hose actuator would sometimes collapse when placed under vacuum trapping air and preventing complete deflation. Spherical corner stops 56 allow hose actuator 12 to be placed in tension without disrupting the flow of air.

It is preferred that angular corner guides 60 be positioned within peripheral backing support 46 in direct contact with corners 54 of picture frame 44. It was found that when pressure was applied that there sometimes was some initial misalignment at corners 54. The use of angular corner guides 60, while not essential, ensures that corners 54 of picture frame 44 are immediately guided to the desired angle as the hose actuator 12 is inflated. As picture frame 44 selected for illustration is rectangular, angular corner guides 60 define a 90 degree angle. With a different polygonal shape, angular corner guides 60 would define a different angle.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A pneumatic press, comprising:
a hose actuator;
a backing support for the hose actuator adapted to be secured to a rigid work surface, a material support adapted to be fixed in spaced relation to the backing support;
means for inflating the hose actuator, thereby causing the hose actuator to expand outwardly from the backing support to press material against the material support; and
means for creating a vacuum in the hose actuator to facilitate insertion and removal of material.

2. The pneumatic press of claim 1, wherein the backing support includes an overhanging structure to direct expansion of the hose actuator outwardly from the backing support.

3. The pneumatic press of claim 1, wherein the backing support is in a linear configuration backing support and the material support is in a linear configuration.

4. The pneumatic press of claim 3, wherein means are provided for placing the hose actuator in tension against the backing support.

5. The pneumatic press of claim 1, wherein the material support is adapted to be secured to a rigid work surface.

6. The pneumatic press of claim 1, wherein the backing support is in a curved configuration and the material support is in a curved configuration.

7. The pneumatic press of claim 1, wherein the backing support comprises a peripheral backing support, and the material support comprises a central material support.

8. The pneumatic press of claim 7, wherein the peripheral backing support defines a polygonal frame.

9. The pneumatic press of claim 8, further comprising a spherical corner stop for changing direction of the hose actuator at corners of the polygonal frame.

10. The pneumatic press of claim 9, wherein angular corner guides are positioned within the peripheral backing support to be in direct contact with corners of material to be pressed, such that the corners of the material are guided into proper alignment as the hose actuator is inflated.

11. A pneumatic press, comprising:
a hose actuator;
a backing support for the hose actuator adapted to be secured to a rigid work surface, the backing support being in a linear configuration and having an overhanging structure to direct expansion of the hose actuator outwardly from the backing support;
a material support adapted to be secured to a rigid work surface in spaced relation to the backing support, the material support being in a linear configuration;
a pump having a first pumping mode and a second pumping mode, in the first pumping mode the pump directs fluid into the hose actuator, thereby causing the hose actuator to expand outwardly from the backing support to press material against the material support, in the second pumping mode the pump draws fluid from the hose actuator, thereby creating a vacuum which collapses the hose actuator to facilitate insertion and removal of material.

12. The pneumatic press of claim 11, wherein means are provided for placing the hose actuator in tension against the backing support.

13. A pneumatic press, comprising:
a hose actuator;
a backing support for the hose actuator adapted to be secured to a rigid work surface, the backing support being in a curved configuration and having an overhanging structure to direct expansion of the hose actuator outwardly from the backing support;
a material support adapted to be secured to a rigid work surface in spaced relation to the backing support, the material support being in a curved configuration;
a pump having a first pumping mode and a second pumping mode, in the first pumping mode the pump directs fluid into the hose actuator, thereby causing the hose actuator to expand outwardly from the backing support to press material against the material support, in the second pumping mode the pump draws fluid from the hose actuator, thereby creating a vacuum which collapses the hose actuator to facilitate insertion and removal of material.

14. The pneumatic press of claim 13, wherein means are provided for placing the hose actuator in tension against the backing support.

15. A pneumatic press, comprising:
a hose actuator;
a peripheral backing support for the hose actuator adapted to be secured to a rigid work surface, the backing support defining a periphery of a polygonal frame;
a central material support in the form of a polygonal plug adapted to be positioned inside the polygonal frame;
a pump having a first pumping mode and a second pumping mode, in the first pumping mode the pump directs fluid into the hose actuator, thereby causing the hose actuator to expand outwardly from the peripheral backing support to press material in the form of a frame against the central material support, in the second pumping mode the pump draws fluid from the hose actuator, thereby creating a vacuum which collapses the hose actuator to facilitate removal of the frame.

16. The pneumatic press of claim 15, further comprising a spherical corner stop for changing direction of the hose actuator at corners of the polygonal frame of the peripheral backing support.

17. The pneumatic press of claim 15, wherein angular corner guides are positioned within the peripheral backing support adapted to be positioned in direct contact with corners of a frame to be pressed, such that the corners of the frame are guided into proper alignment as the hose actuator is inflated.
